(19) United States
(12) Patent Application Publication
(10) Pub. No.: US 2003/0025505 A1
(43) Pub. Date: Feb. 6, 2003

(54) Toy play set

(76) Inventor: Peter Ar-Fu Lam, Torrance, CA (US)

Correspondence Address: Peter Ar-Fu Lam, 20104 Wayne Ave., Torrance, CA, 90503, US

(21) Appl. No.: 10/208,346

(22) Filed: Jul. 30, 2002

Related U.S. Application Data
(63) Continuation-in-part of application No. 09/896,434, filed on Jun. 29, 2001.
Application No. 09/896,434 is a continuation-in-part of application No. 10/118,706, filed on Apr. 8, 2002.
(60) Provisional application No. 60/316,643, filed on Aug. 31, 2001.
(60) Provisional application No. 60/324,202, filed on Sep. 22, 2001.

(51) Int. Cl. G01N 27/416

(52) U.S. Cl. 324/426

(57) ABSTRACT

A toy play set comprising a master toy member and two or more accessory toy members. The master toy member comprises a power source, an audio driving circuit, an audio transducer and one or more receivers. Each of said accessory toy member is configured to receive power from said master toy member by contact and to provide visual response and/or an audio sound through a speaker located at said master toy member.

This is a Continuation In Part application of pending U.S. patent applications 09/896,434 filed Jun. 29, 2001; 10/118,706 filed Apr. 8, 2002; 60/316,643 filed Aug. 31, 2001 and 60/324,202 filed Sep. 22, 2001.

### FIELD OF THE INVENTION

The present invention relates to an electronics toy play set.

### BACKGROUND OF THE INVENTION

Traditional portable interactive learning toy for children provides a sensor pad positioned located beneath a printed game card. The circuit of the sensor pad detects the position of a pen by means of pressure, resistive, capacitive or inductive changes. For many designs, the pen is required to be connected to the game console with a wire for the unit to receive the selection signal. The game play is defined by the pictorial content of the card designed according to an internal program or an external program represented by a game cartridge. This type of learning toy depends of “two dimensional” pictures illustrated on the pictorial card. The player is also required to make use of a pen to indicate the selected answer when a question is asked. According to a research of this invention, it was found that younger child likes to play with toys that are free to move around, rather than a pen connected with a wire. Pen is a tool that can only be handled by an older child. Besides, it was discovered that younger child tends to remember real life article than abstract expressions. In addition, younger child is more ready to learn from three-dimensional toys than to interpret the meanings of a two dimensional picture. It is the objective of this invention to provide a portable learning toy that replaces the pen with real life three dimensional accessory toy free to move around. It should be noted that real life article includes all daily life physical articles that the child can see or feel. Examples of these articles including animals, housewares, furniture, fruits etc. An embodiment of this toy makes use of the high resolution resistor recognition circuit that is capable to resolve resistor tolerance lower than 10%, preferably 5% as disclosed in applicants pending application 60/316,643. Another embodiment of the invention also make use of the technology for a master toy to power up, retrieve voice signals and/or communicate with a series of three dimensional accessory toys as disclosed in applicant's patent applications 60/324,202; 09/896,434 and 10/118,706.

### SUMMARY OF THE INVENTION

The present invention is firstly directed to a hand held toy play set embodiment including a master toy unit and several groups of supporting or accessory toys. The master toy unit includes a power source; a processor; a program directing the processor to control the play pattern of the toy; an electrical to audio transducer such as a speaker to produce sound according to the play pattern; an array of receivers each provided with two contact terminals for interfacing with an external accessory toy article; a structure to receive an illustration card; a circuit to identify the card received; and possibly an array of push buttons for the child to select their choice of answer. Different groups of accessory toy articles are provided to support a game play. For example, multiple animal figures and a card illustrating a zoo are provided to support a game play teaching the child the knowledge of different animals. Another group of accessory toys is represented by a card illustrating a food store and a group of accessory toy members each represented by a 3D food article. Other accessory groups may be provided to teach children about more abstract concepts such as color, shape, numbers and alphabets.

An array of receivers are provided on a top facing surface of the master toy unit. Each receiver is provided with two conductive contact terminals connected to the interfacing circuit located inside the master toy unit. The size of the receiver is to be carefully compromised. If the size of a receiver is too small, it will be difficult for a child to plug the accessory toy article onto the receiver. If the receiver size is too big, not much room will be left for providing illustration on the game card, which is to be placed on top of the receivers.

Illustrations on the game cards add color and fun to the game play. In the prior art embodiment, the game card is critical as it illustrates all the different choices of answers to be selected by the child. The child select an answer by pressing a pen down onto the two dimensional pictures illustrated on the card. Since the improved game pad enables the child to play with 3D accessory toys of real life shape, there is more freedom to design the illustrations and improve the play value of the toy set. For example, the game card can be printed with a short story, illustrated with words or pictures. Particular word location is replaced by a vacant space for the kid to fill in a proper accessory toy character. In this case, each of the vacant spaces of the card will be replaced by a hole adequate for an accessory toy member to make connection with the located beneath the hole. It should be noted that the position of the hole should be properly aligned with the position of the receiver located beneath it. The theme of the card should be in line with the questions asked. For that reason, each game card is designated to work with a specific game program. Accordingly each card is provided an identifier for the processor to understand which card had been inserted into the master toy unit, and which game is to be played. Card identification can be provided by bar codes, magnetic strips or any other means that provides proper identification information to the processor.

Game programs may be stored inside the digital memory elements located inside the toy, or inside the game cartridges to be plugged into the master toy unit. External game cartridges enable the master toy unit to work with game to be launched at a later time. The digital memory elements are represented by ROM (Read Only Memory), RAM (Random Access Memory), flash memory and any other type of digital data storage devices capable of providing digital data to the microprocessor of the master toy unit. The main function of the digital memory elements is to store the game program, and the voice/melody messages required to support the game play.

Different groups of accessory toy members are required to support different game themes. Each toy member should be provided an identity circuit capable of interfacing to the processor through the metal contacts located inside the receiver. Typical identity circuit is represented by an integrated circuit, a resistor, or other working passive component to provide identity information. Applicant's pending U.S. patent application Ser. Nos. 09/896,434; 10/118,706 and 60/324,202 disclosed circuits enabling a portable master toy unit to power up an IC located inside an external accessory toy through the two conductive contacts, and to retrieve audio and digital information stored inside the IC. Alternately the accessory toy member can be identified by a resistor of specific value installed inside the accessory toy member. The concept of using a resistor for identification purpose and a circuit capable to identify less than ten different resistor values was firstly introduced by the applicant in an ARCO Once Upon A Time Playset designed for Mattel Toys during April 1994. Applicant's U.S. patent application Ser. No. 60/316,643 disclosed more advanced circuits and IC designs capable of recognizing over 90 high resolution resistor identities. Since the commodity resistors are provided with 5% tolerance, it is reasonable to provide a circuit that can resolve 10% resistor value resolution.

Using IC for identification purpose is relatively expensive. Using resistors or capacitors for identification purpose is a cheaper solution but the number of possible identifications is comparatively limited. Another solution resulted during the research of this invention is to provide each group of accessory toys with a specific shaped foot print, or a foot print having a special shaped lock key. The holes of the game card for playing with the specific accessory group is also formed with the same shape of foot print of that group, such that accessory characters from another group is not allowed to make contact with the receivers of the master toy unit. In this way, the same group of resistor values can be repeatedly used for other different groups of accessory toy figures. It is also a requirement for the contact design of the receivers to be universal and independent of the shape of the accessory toy foot print. A convenient design is a concentric female socket similar in nature to the sockets for most small electronics products to connect with the power adaptors. When connectors in other shapes are used, the orientation of the socket is to be carefully positioned to be in line with the orientation of the specified foot print. The identity of each accessory toy member represents a unique personality that enables the game program to determine if a correct answer has been provided by the player, or to produce a proper audio and/or visual response. Audio responses are provided by converting an audio signal stored inside the digital memory elements of the master toy unit, the game cartridge, or inside the IC located inside the accessory toy member. Visual responses can be achieved by providing power through the contacts terminals to a light bulb, LED or motor installed inside an accessory toy member. As compared with the traditional prior art learning pads, the 3D learning pad disclosed enables the child to play with the individual accessory toy members, to feel it and to spend time and get more familiar with it. In addition, choice of answers from the 2D graphics printed on the game card is very limited for the traditional prior art learning pad, due to the size limitation of the game card. A manufacturer is now able to provide a much bigger number of accessory toy members for the child. It should be noted that when the game is targeted for the older kids, the 3D characters of the accessory toy members can be replaced by 2D photographs or pictures positioned on a podium structure of suitable foot print to reduce cost. From here it can be observed that the improved learning pad design provides more exciting audio/visual responses and incentives for the children to learn.

To add more complexity to the game play, an array of switches can be provided along the side of the game pad. These switches may be color coded, sign coded or letter coded for the child to enter an answer without using an accessory toy member. These switches are useful for selecting an answer not related with real life articles. Typical examples of these selections are taste such as sweet, bitter or sour; feeling such as happy, sleepy or anxious. When the switches are aligned in position with the receivers, special game plays can be designed allowing the child to interactively making use of both the accessory toy members and the side switches to play the game.

It had already been mentioned that it is easier and more attractive for the younger child to learn with removable three dimensional accessory toys that provide audio/visual responses. Accordingly the features of the first toy play set embodiment is to be simplified to target for this group of younger preschool children. A very simple embodiment of the invented play set is formed by removing the game cartridge, the game card, the game card sensor, the side switches and all the receivers except a single receiver is kept to interface with the external accessory toy members. The external toy members are personalized by a two dimensional picture or preferably a three dimension real life article for the younger children. These accessory toy members are preferably to be further characterized by audio and/or visual responses. A light bulb, LED or motor can be provided inside the accessory toy article to produce visual effects. When audio response is desirable, a voice chip is provided inside the accessory toy article. The voice chips receive power from the master toy unit and produce audio signal to be played by the master toy unit. Batteries and speakers should be provided only inside the master toy unit to save product cost. The processor positioned inside the master toy unit may be replaced by a special IC configured to convert the audio signal received from an external accessory toy member into a signal suitable for driving the speaker. Preferably, this special IC chip is designed to drive the speaker in both directions so as to make full use of the dynamic range of the speaker. Integrated circuit designed for this specific Green Voice function had been disclosed in applicants issued U.S. Pat. Nos. 5,990,739 and 6,163,214.

The novel features of the invention are set forth with particularity in the appended claims. The invention will best be understood from the following description, when read in conjunction with the accompanying drawings.

### DESCRIPTION OF THE DRAWINGS

FIG. 1 illustrates a first embodiment of the 3D learning pad play set;

FIG. 2 illustrates an embodiment of the electronics circuit designed for the play set of FIG. 1;

FIG. 3 is an embodiment illustrating a master toy unit that provide powers to an external accessory toy member through two contact terminals and to retrieve audio signals from said external accessory toy member.

FIG. 4 illustrates a circuit designed for an external accessory toy member to provide audio signal through the two contact terminals back to the master toy unit;

FIG. 5 is a circuit designed for the master toy unit to power up the circuit of FIG. 4 and to convert the audio signal received from the external accessory toy member for driving a speaker;

FIG. 6 is an alternate circuit of FIG. 5 to drive the speaker according to the Green Voice specification;

FIG. 7 is one of the prior art circuits first introduced by the applicant to provide identity information with a resistor; and

FIG. 8 is an improved embodiment circuit introduced by the applicant to identify resistor values finer than 5% resolution.

### DETAILED DESCRIPTION

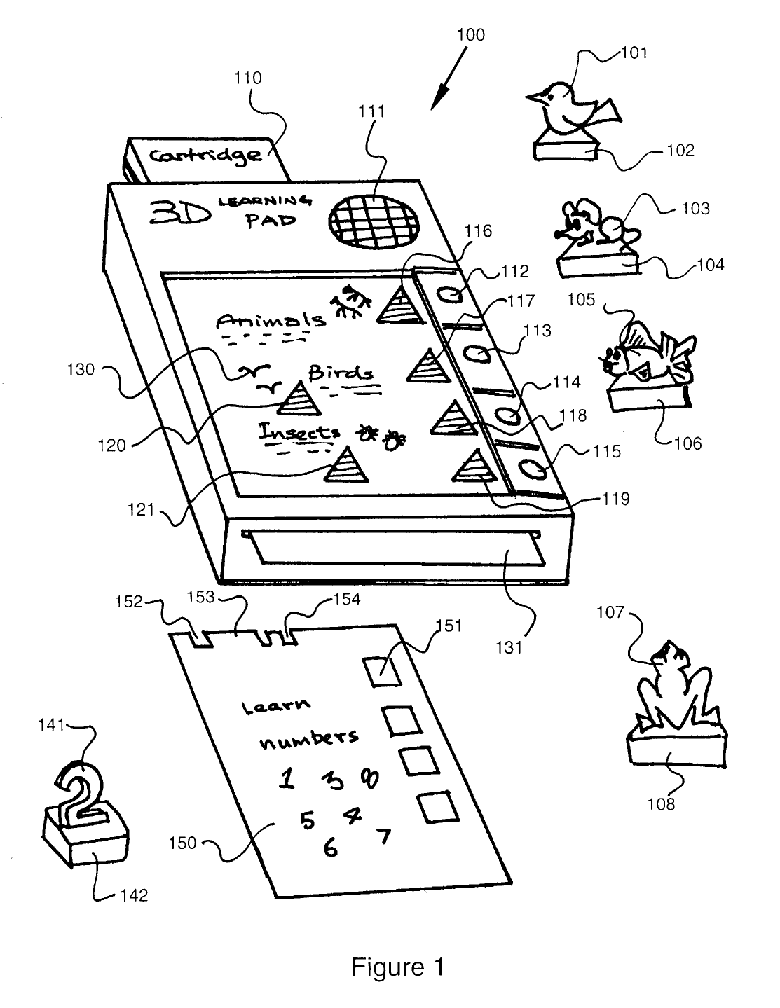

Attention is initially directed to FIG. 1, which depicts the combined application of a master toy embodiment 100 and multiple accessory toy members 101, 103, 105, 107 and 141. The master toy unit 100 comprises of a game cartridge 110; the speaker 111, a game card 131 and a line up of side switches 112 to 115. Inside the cartridge 110 are memory devices that stores a program to direct the game play. The game card 131 is provided with triangular holes 116 to 119 and 120, 121. Underneath these triangular holes are receivers structured to receive an external accessory toy member represented by the three dimension characters 101, 103, 105 and 107. Each of the receivers is provided with two contact terminals configured to make contact with the circuit of the accessory toy members when they are received by any of the receivers. An array of receivers are located at the panel beneath the game card 131. The game cards 131 and 150 are carefully designed such that the positions of each holes 116 to 119, 120, 121 and 151 is properly aligned with the location of a receiver. Inside each 3D accessory toy members is an identifier circuit, a voice generating circuit, a light bulb, a LED or a motor. In an example of a game play, the processor derived a message from the game cartridge and ask: “Find an animal and place it on the first line!”. If the child picks the fish 105 for the receiver 116, another message will be announced to ask the child to try again. If the mouse 103 is selected for the receiver 116, the child is praised for the correct answer selected. Once the receivers 116 to 119 are correctly filled, the master toy unit may ask further question about the game play. A further example question is “Please select an item that is able to fly!”. The correct answer is to select the button 113 by the side of the receiver 117 that accommodated the bird 101. It should be noted that all the accessory toy members 101, 103 105 and 107 belong to the same group that works with the game card 131. These accessory toy members are characterized by a triangular shape foot print. Game card 150 works with another group of 3D characters. Since the theme of the game card 150 is to learn numbers, all the accessory toy members are represented by 2D or 3D shapes of numbers exemplified by the toy member 141. It should be noted that the shape of the hole on the card 150 is designed to match with the foot print of the toy member 141. They are all of the same size square shape. In addition to the different shape of foot print required to identify the groups of accessory toy characters to be used, the master toy unit is designed to identify which game card was inserted. This can be achieved by providing an identifier to each of the game card, such as bar code and magnetic stripe. The slots 152, 154 and covered area 153 is designed for an optical reader to detect the identity of the game card 150. Additional game cards and game cartridges may be provided to enrich game play. Different games should be supported with matched cartridge, game cards and the appropriate group of accessory characters.

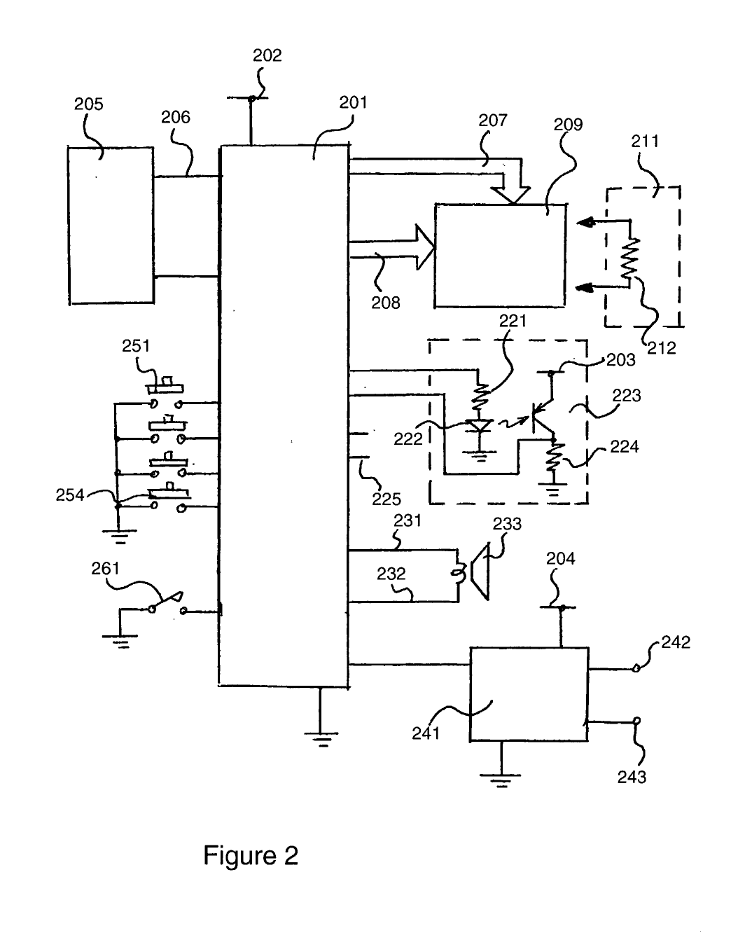

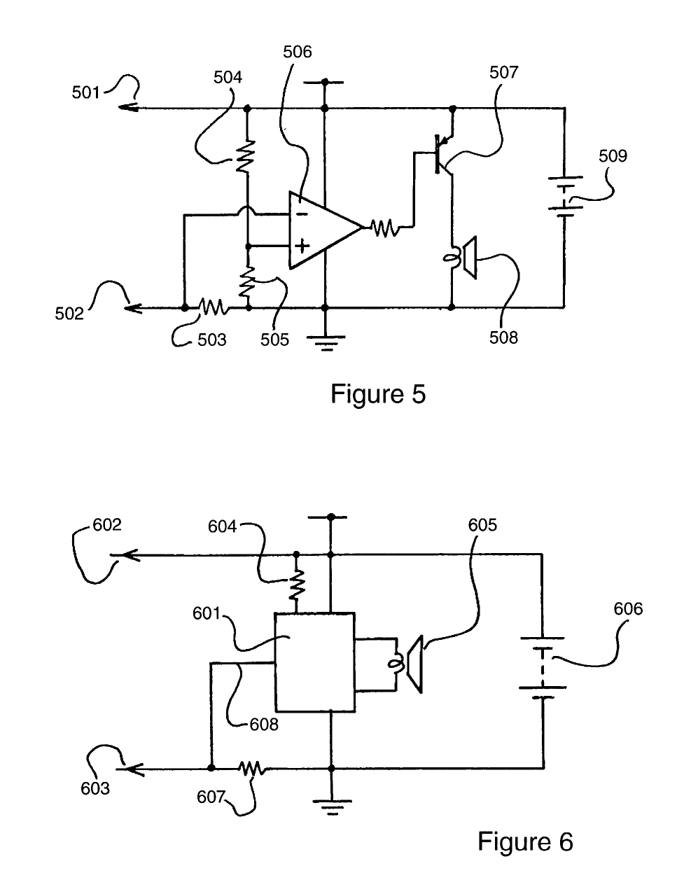

Attention is now directed to FIG. 2, which illustrates the circuit design to support the toy play set of FIG. 1. Memory device 205 represents the external game cartridge 110 of FIG. 1. It stores the game program to be executed by the processor 201 as well as some data that represents the audio signal to be produced through the speaker 233. Horizontal bus 208 and vertical bus 207 controls the interfacing circuits connected to the receiver array. Block 211 represents an external accessory toy member identified by the resistor 212. Push button switches 251 to 254 represents the switches 112 to 115 of FIG. 1. When the game card 131 is first pushed into the slot of the game pad, the edge of the card triggers the normally open sensor switch 261 to inform the processor 201 of the presence of a game card. The processor turns on the LEDs 222 of the game card detection bus that include the driving lines 225. The presence of a slot such as 152 and 154 allows the light of the LED 222 to be received by the light sensor 223. The encoded on/off condition of the slots is then interpreted by the processor 201 and the identity of the card 131 is then recognized. Circuit block 241 represents the equivalence of the circuit shown in FIG. 5 or 6 that controls the electrical power to be supplied to an external accessory circuit and/or to receive data or audio signal from an external IC.

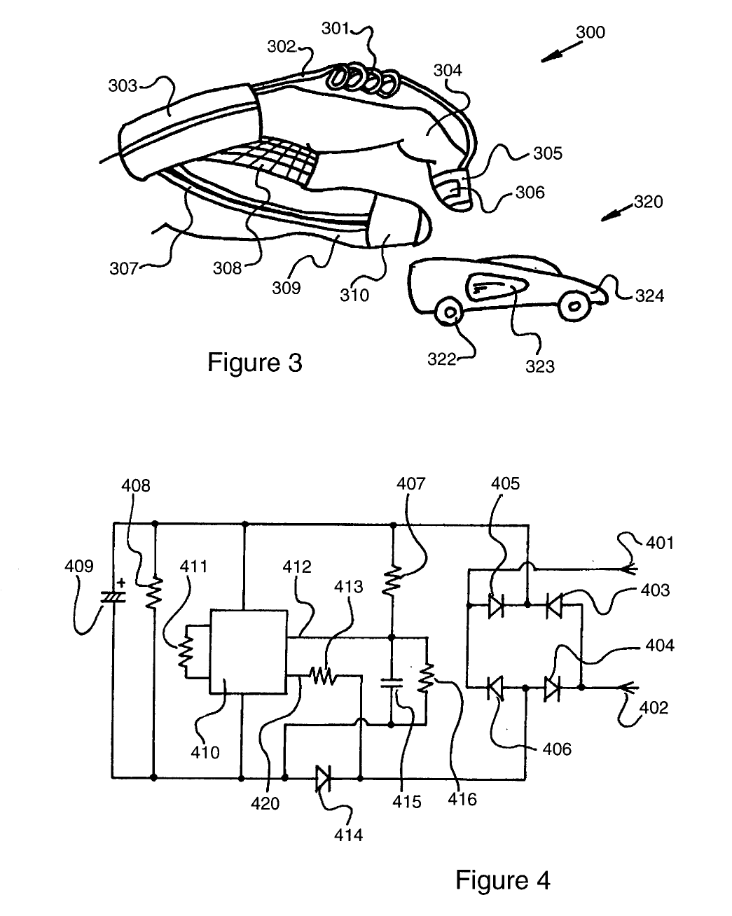

FIG. 3 illustrates an alternate example of a toy play set arrangement that enables a master toy unit 303 having a power supply and a speaker to interface with an external accessory toy member 324. The controller 300 comprises a compartment 303, a velcro tape 308 to attach the compartment 303 to a human hand; two finger caps 310, 305 for attaching to the thumb 309 and the index finger 304. On each of the finger cap is a conductive contact terminal 306. Each contact terminal is connected to the compartment 303 by conducting wires 307 and 302. The conductive wire 302 has a flexible; elastic or coiled segment 301 for adjusting the distance between the finger cap 305 and the compartment 303. Alternately, the exposed length of the wire 307 can be adjusted by hiding some segment of the wire inside the compartment 303. Inside the compartment 303 are batteries that provide power to the external target article, the toy car 324. Two contact terminals 323 are positioned at the two sides of the toy car 324 such that when the car is picked up by the fingers 304, 309, each contact terminal 306 make contact with the corresponding contact terminal 323 of the car and provide power to the electrical circuit inside the car. A motor linked to the wheels of the car is provided inside the car. The terminals of this motor are connected to the contact terminals 323. As soon as the finger contact terminals 306 touches the contact terminals 323, the motor is powered by the batteries inside the compartment and starts to run. Alternately an electricity to light transducer such as LED is included inside the car. The LED will be lit when the car is picked up. In an alternate embodiment the electrical circuit located inside the car is an identifying circuit, which provides some electrical identification characteristics, the electrical circuit inside the compartment picks up the identification through the finger contacts and response with some sound effect appropriate with the characteristics of the target article, the car 324. For example, when an ambulance is picked up, a siren sound is generated according to the sound stored in the voice chip embedded inside the car 324. The embodiment of FIG. 3 disclosed in applicant's prior patent application disclosed the same operating principle for the receiver to interface with the external accessory toy members.

FIG. 4 illustrates a preferred embodiment of a sound generating circuit located inside an accessory toy member. Contact terminals 401 and 402 receive power from the master toy unit in either polarity. The diodes 405 and 404 conduct when the terminal 401 is positive relative to the contact terminal 402. Diodes 403 and 406 conduct when the voltage at terminal 402 is positive relative to the contact terminal 401. The polarity correction circuit can be provided inside an integrated circuit or by discrete components locate outside the integrated circuit. The feeding power charge up the capacitor 409 which provides a small energy to maintain proper function of the sound generating integrated circuit 410 when the power supply is momentary interrupted. Resistor 408 discharges the energy stored inside the capacitor 409 when the external power is removed. The oscillator resistor 411 determines the clock frequency of the voice generation integrated circuit 410. The data stores inside the integrated circuit 410 represent a voice. The voice generating integrated circuit 410 generates pulse width modulated pulses that are suitable to drive a speaker. The pulse width modulated signal is transmitted through the output pin 420 and sinks supply line current through the resistor 413. The value of the resistor 413 as compared with the internal impedance of the master toy unit circuitry forms a potential divider that defines the amplitude of the pulsing signal superimposed on the DC level as shown FIG. 5. The diode isolates the power supply smoothing circuit formed by the capacitor 409 from being interrupted by the pulsing signal driven by the output line 420. Resistor 407 and capacitor 415 forms a delay trigger circuit or reset circuit that enables the integrated circuit 410 to be activated at a short delay after the external power is received. At power up, the delay trigger circuit prohibits the integrated circuit to be triggered until it is stabilized.

It should be noted that the pulse width modulated output, although capable to drive the speaker directly as shown in FIG. 5, drives the speaker only in one direction. This arrangement does not make use of the full dynamic range of the speaker and therefore is inefficient to deliver loud sound volume. The optimal high efficiency audio arrangement is to drive the speaker 508 in both directions. FIG. 6 illustrates an integrated circuit custom designed according to the subject invention to extract audio signals from the power line and to directly drive the speaker 605 in both directions. In this arrangement the pulsing signal illustrated in FIG. 4 can no longer be pulse width modulated signal used for directly driving a speaker. Instead the pulsing signal generated is preferred to be pulse code modulated (PCM) signal that include a sign bit to tell the polarity of the speaker driving current. This PCM pulses are converted by the integrated circuit 601 into pulse width modulated signals to drive the speaker 605 in both directions. Similar to the resistor 503 in FIG. 5, resistor 607 defines the internal impedance of the master toy power supply circuit when viewed from the contact terminals 602 and 603. The pulses received from the power line is extracted by the integrated circuit 601 according to the predefined input threshold of the input pin 608.

Attention is now direct to FIG. 5 which illustrates the power supply and sound decoding circuit suitable for receiving the sound signal provided by the accessory toy member circuit of FIG. 4. The power source represented by the battery 509 powered both the comparator 506 and also the sound generating integrated circuit located inside the accessory toy member. The resistor 503 defines the internal impedance of the power line as viewed by the electronics circuit located inside the accessory toy members. The impedance is required to superimpose the pulsing signal on top of the DC supply voltage. Resistors 504 and 505 form a reference potential divider for the comparator 506. The reference voltage is set at a level just below the voltage level when the resistor 503 is connected to the diode circuit and resistor 413 of FIG. 4. Accordingly the comparator 506 in response to the pulses generated by the IC 410, will turn the transistor 507 on and off. The pulse width modulated audio signal will be converted into audible sound signals through the audio transducer represented by the speaker 508.

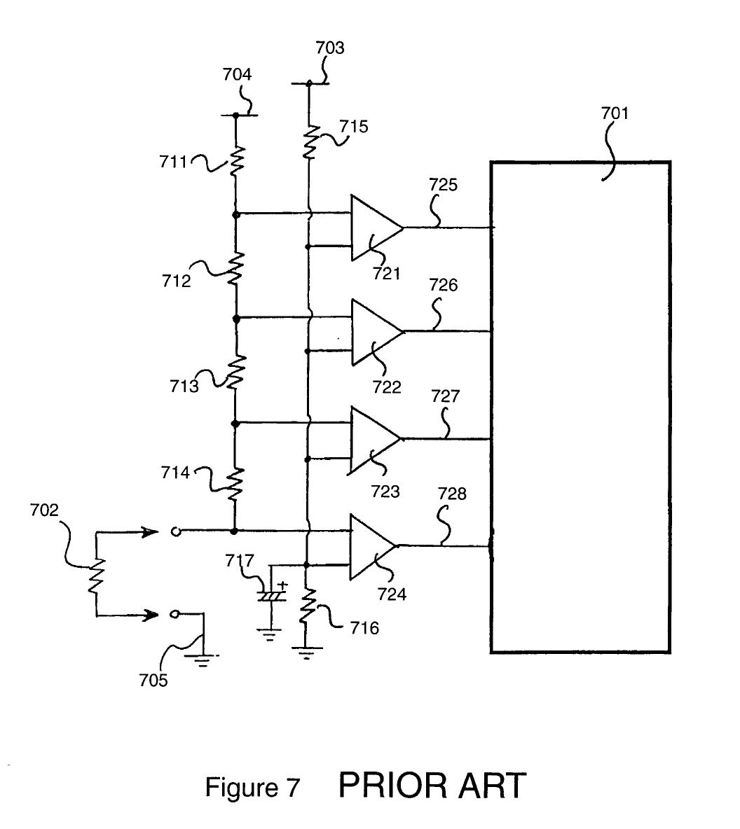

FIG. 7 shows one of applicant's prior art circuit that make use of an external resistor for identifying the personality of an accessory toy member. This concept was invented by the applicant when he designed a toy named ARCO—Once Upon A Time Playset for Mattel Inc. during April 1994. Resistor 702 is one of a series of external resistors, each embedded into an external accessory toy member, such as the bird 101 or number 2 141 of FIG. 1. When connected to the junction point of reference resistor 714 and the input terminal of the comparator 724, the resistors 702, 714, 713, 712 and 711 form a ladder network which provides different sensing voltages to the input of the comparators 721 to 724. The reference comparison voltage of the comparators 721 to 724 are defined by the potential divider resistors 715 and 716. This sensing voltage is stabilized by the capacitor 717. Assuming that the reference comparison voltage is set at 0.5VB, that is half of the power supply voltages 703, any input voltage lower than 0.5VB will provide a logic level change, that provide switched signal at the output of the comparator. Assuming the value of resistors 711 is 100 kohm, resistor 712 is 30 kohm; resistor 713 is 10 kohm, and that of resistor 714 is 4.7 kohm; then a resistor value of 140 kohm for resistor 702 will trigger comparator 724 but not the other three comparators. A resistor value of 130 kohm for resistor 702 will trigger both comparators 724 and 723. A resistor value of 100 kohm for resistor 702 will trigger comparators 722 to 724 but not 721. If the value of resistor 702 is smaller than 51 kohm, then all comparators will be triggered. The micro-controller 701 directs a sound response according to the responses of the comparators 721 to 724. It should be noted that the reference comparison voltages provided to the reference inputs of comparators 721 to 724 can be changed, that will provide a little more tolerance margin between the values of the identity resistors 702. Since the triggering signals 725 to 728 trigger the controller chip 701 by passing over the triggering threshold of the input pins, the comparators 721 to 724 may be removed if the triggering levels of the controller 701 are consistent and vary in proportion during the full operating voltage range. This prior art circuit design exhausted the range of identity resistance from 51 kohm to 140 kohm for providing only four working identity resistance values. It is the goal of this invention to provide a more superior circuit to resolve more than 30 identity resistances within this range, each has a tolerance of +/−5% from the neighboring resistance value.

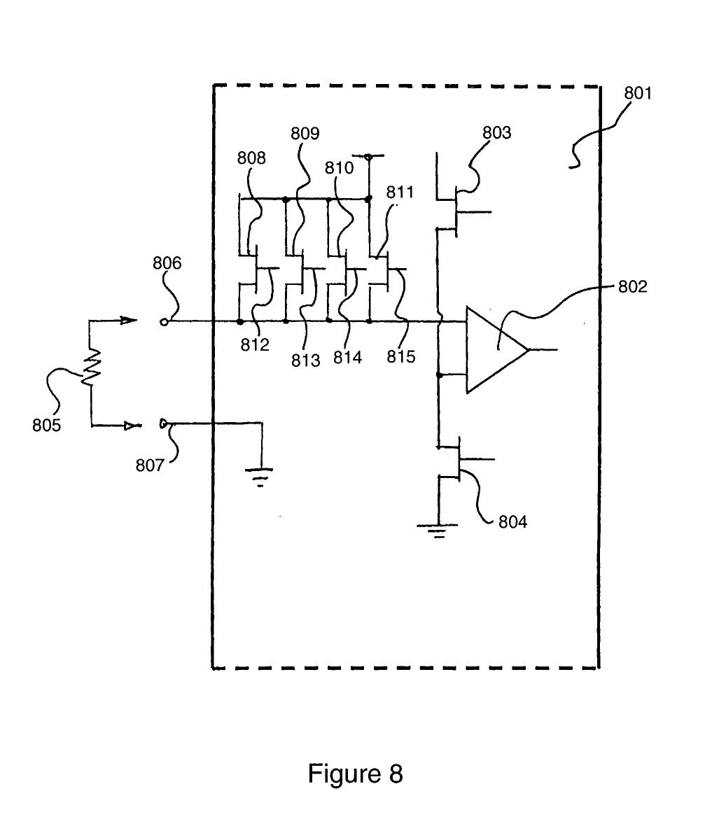

FIG. 8 illustrates a preferred embodiment that provides a much higher degree of resistor resolution disclosed in applicants pending patent application. The controlled current source is represented by the switching gates 808 to 811. The control lines 812 to 815 are connected to the CPU circuit of the microcontroller 801. Each gate of 808 to 811 is carefully designed and etched to provide a precise current required to resolve the precise resistance value of 805. If a total of 97 different resistance values from 100 ohm to 1 Mohm are to be detected, a total of 97 precision switched current choices are to be provided. These precision switched current can be provided by a group of switched gates arranged in parallel, as shown, or in series, or in the combination of series and parallel arrangement. The voltage developed across the identity resistor is sent to a threshold detector. Alternately, a fewer number of reference currents may be pumped to the identity resistor and the voltage developed is compared by an internal comparator circuit. In this case, the switching circuit represented by the gates 808 to 811 should be relocated to set the comparison reference voltage of the comparator 802, as represented by the reference gates 803 and 804. In order to further enhancing the tight tolerance resolution capability under the variation of battery supply voltage, an internal regular is recommended for the detection circuit.

Technically it is extremely demanding to differentiate the current pumped into a broad range of two close values resistors, such as 100 ohm and 110 ohm; all the way up to the pair of 910 kohm and 1 Mohm resistors; especially under a big variation of working voltage and possibly an electrically noisy working environment. Another difficulties is the variable cut in current required by a threshold detection circuit under mass volume production, especially for it to work with the high resistance range. If the technology of choice is CMOS, the research of this invention directs the desire to put in an external bipolar transistor or a darlington to buffer the threshold sensor, or to amplify the sensing current.

From the foregoing, it should now be appreciated that the applicant has disclosed herein embodiments of a master toy unit configured to power or interface with a family of accessory toy members for recognition of identity, and for producing light, sound and motion responses. It is intended that the accessory toy members do not require internal battery as a power source. The electrical power needed by the accessory toy member is derived from the master toy unit through the contact terminals. Particularly, it should be noted that there are different variations of contact designs, different ways to provide personality to the accessory toy members, different way to provide identity to game cards and different ways to integrate the play pattern among the game card, the software program and the accessory toy members. It should also be noted that the different unique features of the illustrated embodiment can be enhanced, reduced or simplified to meet the different needs of the children of different ages. Although detailed embodiments of the invention have been disclosed, it is recognized that variations and modifications, all within the spirit of the invention, will occur to those skilled in the art. It is accordingly intended that all such variations and modifications be encompassed by the appended claims.

I claim:

1. A toy play set comprising:
a master toy member having a processor, a sound transducer and at least two receivers each provides at least two contact terminals for interfacing an external accessory toy member;
at least first and second accessory toy members each having at least two contact terminals to interface with said receivers for said processor to provide a different response according to a programmed play pattern; and
one or more cards configured to position on top of said receivers; each of said card is further provided with at least two holes aligned in position with at least two of said receivers for that receivers to receive an external accessory toy member.

2. A toy play set comprising:
a master toy member having a processor, a sound transducer and at least two receivers each provides at least two contact terminals for interfacing an external accessory toy member;
at least first and second accessory toy members each represents a different real life article; each of said accessory toy members having at least two contact terminals to interface with said receivers for said processor to provide a different response according to a programmed play pattern.

3. The toy play set of claim 2 further comprising one or more cards configured to position on top of said receivers; each of said cards is further provided with at least two holes aligned in position with at least two of said receivers for that receivers to receive an external accessory toy member.

4. The toy play set of claim 2 wherein each of said cards comprises an identifier configured to enable said processor to identify the nature of said cards.

5. The toy play set of claim 2 wherein said accessory toy members are identified by resistors or capacitors of 10% or finer resolution.

6. The toy play set of claim 2 wherein the shape of the holes are different for two of said cards enabling each of said cards to work with a different group of accessory toy members.

7. A toy play set comprising:
a processor;
a power source;
memory means representing a program to define the play pattern of said toy set;
a sound transducer;
a set of accessory toy members each having a personality different from each other, each accessory toy members comprises at least two contact terminals;
two or more receivers, each configured with at least two mating contact terminals for interfacing with a member of said accessory toys; and
two or more cards each defines a different play theme or play patterns to work with at least one of said accessory toy members.

8. The toy play set of claim 7 wherein said toy play set comprises at least four receivers arranged on a plane.

9. The toy play set of claim 7 wherein any of said cards comprises a hole aligned in position with any of said receivers for receiving an accessory toy member.

10. The toy play set of claim 8 wherein the electrical circuits connected to said receivers are arranged in a matrix form for interfacing or controlling by said processor.

11. The toy play set of claim 7 wherein at least two of said cards comprise identifiers configured for identity recognition by said processor.

12. The toy play set of claim 7 wherein at lease one accessory toy member represents a real life article.

13. The toy play set of claim 7 wherein at least one accessory toy member is in the shape of a three dimensional article.

14. The toy play set of claim 7 wherein said memory means is represented by an external plug in cartridge.

15. The toy play set of claim 7 comprising at less two different groups of accessory toy members, each dedicated to a different play theme.

16. The toy play set of claim 15 wherein each accessory toy member group has a different foot print identity.

17. The toy play set of claim 16 further comprising at least two cards each having holes with shape matching the different foot print identities of said accessory toy member groups.

18. The toy play set of claim 7 wherein said processor, sound transducer and receivers forms a master toy unit; and each accessory toy member comprises an IC for sending identification or signal represents a sound to said master toy unit through the contact terminals of said receivers.

19. The toy play set of claim 7 wherein said processor, sound transducer and receiver forms a master toy unit; and each accessory toy member comprises a resistor or capacitor for identifying the characteristics of said accessory toy member.

20. The toy play set of claim 19 wherein said accessory toy members are identified according to resistors or capacitors of 10% or finer resolution.

21. The toy play set of claim 7 further comprising two or more trigger switches, wherein each trigger switch corresponds to a specific receiver.

22. The toy play set of claim 7 wherein at least one accessory toy member comprises a light bulb, an LED or a motor to provides visual effects.

23. A toy play set comprising:
a power source;
a master toy member having a sound transducer;
a receiver having at least two contact terminals to provide to an external accessory toy members; and
first and second accessory toy members each having at least two contact terminals for interfacing with said receiver for powering up a voice IC, or a light transducer or a motion transducer located inside said corresponding accessory toy member; wherein said first and second accessory toy members are of different personality defined by a different two dimensional picture or three dimensional article.
